(19) United States
(12) Patent Application Publication
(10) Pub. No.: US 2008/0170100 A1
(43) Pub. Date: Jul. 17, 2008

(54) LIQUID EJECTION APPARATUS

(75) Inventor: Kunihiko MATSUHASHI, Matsumoto-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/013,067

(22) Filed: Jan. 11, 2008

(30) Foreign Application Priority Data
Jan. 12, 2007 (JP) 2007-004427

(51) Int. Cl. B41J 2/165

(52) U.S. Cl. 347/33

(57) ABSTRACT

A liquid ejection apparatus for ejecting a liquid onto a target is provided. The liquid ejection apparatus is provided with a liquid ejection head, a conveying mechanism, a moving device and a wiping device. The conveying mechanism conveys a target along the nozzle forming surface toward a facing location which faces the nozzle forming surface provided on the liquid ejection head from a side of the facing location. The moving device makes at least one of the liquid ejection head and the conveying mechanism approach and move away from the other in a predetermined direction while maintaining a state where the nozzle forming surface and the conveying mechanism face each other. The wiping device has wiping members for wiping the nozzle forming surface. The wiping members are arranged on a side of the conveying mechanism corresponding to the liquid ejection head in the predetermined direction.

### CROSS-REFERENCE TO RELATED APPLICATION

This application is based upon and claims the benefit of priority from prior Japanese Patent Application No. 2007-004427, filed on Jan. 12, 2007, the entire content of which is incorporated herein by reference.

### BACKGROUND

1. Technical Field

The present invention relates to a liquid ejection apparatus such as an inkjet printer.

2. Related Art

An inkjet printer (hereinafter referred to as “printer”) is disclosed in, for example, Japanese Laid-Open Patent Publication No. 2005-67127, as a known liquid ejection apparatus for high-speed printing on paper, which is a target. This printer is a full line type printer having a recording head 101 serving as a liquid ejection head and a conveying mechanism 102 located below the recording head 101. As shown in FIG. 12, the shape of the entire recording head 101 corresponds to the length of a sheet of paper sheet 100 in a direction along the width (Y direction), which is the direction perpendicular to the direction in which the paper sheet 100 is conveyed (X direction). The conveying mechanism 102 conveys the paper sheet 100.

In this printer, the recording head 101 is provided with a plurality of unit head portions 103 which eject ink, which is liquid, onto the paper sheet 100. That is, the recording head 101 is formed of a front set of unit heads having a plurality of unit head portions 103 placed at equal intervals in the Y direction and a rear set of unit heads having a plurality of unit head portions 103 placed at equal intervals in the Y direction toward the side opposite to the X direction from the front set of unit heads. The conveying mechanism 102 is provided with a drive shaft 104 which extends in the Y direction in FIG. 12, and the drive shaft 104 rotates as a result of the drive force provided by a drive motor 105. In addition, the conveying mechanism 102 is provided with a first driven shaft 106A which is placed forward of the drive shaft 104 along the X direction, and a second driven shaft 106B which is placed rearward of the drive shaft 104 along the X direction. In addition, between the drive shaft 104 and the first driven shaft 106A, and between the drive shaft 104 and the second driven shaft 106B, a plurality of endless conveying belts 107 are provided at predetermined intervals. Each conveying belt 107 is located between an adjacent pair of the unit head portions 103 along the Y direction.

In addition, as shown in FIG. 13, the above described printer is provided with a maintenance unit 108 for the maintenance of each unit head portion 103 below each conveying belt 107. This maintenance unit 108 is provided with a plurality of wiping members 109 which individually correspond to each unit head portion 103. In addition, when wiping a nozzle forming surface 110 of each unit head portion 103, each wiping member 109 rises toward the nozzle forming surface 110 of each unit head portion 103 between adjacent conveying belts 107 in the Y direction. Each wiping member 109 slides in the X direction in a state where the upper end portion of each wiping member 109 makes contact with the nozzle forming surface 110 of each unit head portion 103, and thus, the nozzle forming surface 110 of each unit head portion 103 is wiped with each wiping member 109.

When the width of each wiping member 109 in the Y direction is smaller than the width of each unit head portion 103 in the Y direction, ink is wiped off in the wiping region which makes contact with a wiping member 109 in the nozzle forming surface 110 of each unit head portion 103, while ink is not wiped off in the non-wiped region, which cannot be wiped with any wiping member 109. In addition, in the non-wiped region on the nozzle forming surface 110, ink that has been wiped off the wiping region on the nozzle forming surface 110 sometimes partially moves to the non-wiped region from the two end portions of the wiping members 109 in the Y direction when the nozzle forming surface 110 is wiped with the wiping members 109. As a result, ink that fails to be wiped off the nozzle forming surface 110 with the wiping members 109 remains in the non-wiped region on the nozzle forming surface 110 in each unit head portion 103, and there is a risk that this ink may adhere to a sheet of paper P during printing.

However, the width of each conveying belt 107 in the Y direction is smaller than the intervals between adjacent unit head portions 103 in the Y direction, and therefore, it becomes possible to provide wiping members 109 of which the width in the Y direction is great in the Y direction of the unit head portions 103 in the maintenance unit 108. In addition, when such wiping members 109 are provided, the entirety of each unit head portion 103 can be wiped off with each wiping member 109 when the nozzle forming surface 110 of each unit head portion 103 is wiped. Accordingly, printing defects, such that ink which fails to be wiped off the nozzle forming surface 110 adheres to the paper sheet 100 at the time of printing on the paper sheet 100, are prevented.

Incidentally, in order to lift and lower the wiping members 109, which are wider than the unit head portions 103 in the Y direction, between adjacent conveying belts 107 in the Y direction, it is necessary for each conveying belt 107 to be formed such that the width of each in the Y direction is narrower than the intervals between adjacent unit head portions 103 in the Y direction. When the width of each conveying belt 107 in the Y direction is small, however, there is a risk that the performance of conveying paper sheet 100 by the conveying mechanism 102 with such conveying belts 107 may be lowered.

Therefore, as a method for preventing the performance of conveying paper sheet 100 by the conveying mechanism 102 from being lowered, three or more sets of unit heads (for example, four sets) are arranged in the X direction, and in each set of unit heads, the intervals between adjacent unit head portions 103 in the Y direction are greater than the intervals between the unit head portions 103 shown in FIG. 12. In addition, a method for forming a conveying mechanism 102 according to which the width of each conveying belt 107 in the Y direction becomes greater than the width of the conveying belt 107 in FIG. 12 in the Y direction is possible. In this case, however, the recording head 101 becomes great in size in the X direction, and as a result, the entire printer becomes large in size.

### SUMMARY

Accordingly, it is an objective of the present invention to provide a liquid ejection apparatus that prevents the size of the apparatus from becoming large in size, and is capable of reliably wiping the entirety of the nozzle forming surface of the liquid ejection head, irrespectively of the form of a conveying mechanism.

To achieve the foregoing objective and in accordance with a aspect of the present invention, a liquid ejection apparatus for ejecting liquid onto a target is provided. The liquid ejection apparatus includes a liquid ejection head, a conveying mechanism, a moving device, and a wiping device. The liquid ejection head has a nozzle forming surface. The liquid ejection head has a nozzle opening through which liquid is ejected. The conveying mechanism conveys the target along the nozzle forming surface toward a facing location which faces the nozzle forming surface from a side of the facing location. The moving device makes at least one of the liquid ejection head and the conveying mechanism approach and move away from the other in a predetermined direction while maintaining a state where the nozzle forming surface and the conveying mechanism face each other. The wiping device has a wiping member for wiping the nozzle forming surface by sliding against the nozzle forming surface. With respect to the predetermined direction, the wiping member is placed on a side of the conveying mechanism corresponding to the liquid ejection head.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIGS. 1A and 1B are schematic diagrams showing an inkjet printer according to one present embodiment;

FIG. 2A is a schematic plan view showing a support frame of the printer in FIG. 1;

FIG. 2B is a schematic side view showing the support frame in FIG. 2A;

FIG. 2C is a schematic side cross-sectional view showing a mechanism for moving the support member of the printer of FIG. 1;

FIG. 3A is a schematic plan view showing a recording head of the printer in FIG. 1;

FIG. 3B is a schematic side view showing a mechanism for moving the recording head in FIG. 3A;

FIG. 4 is a schematic plan view showing the support member of the printer in FIG. 1;

FIG. 5 is a schematic plan view showing the support member of the printer in FIG. 1;

FIG. 6 is an enlarged perspective view showing a portion of the support member in FIG. 4;

FIGS. 7A and 7B are schematic diagrams schematically showing a wiping mechanism of the printer in FIG. 1;

FIGS. 8A and 8B are schematic diagrams showing the relationship between a second protrusion and an electromagnet;

FIG. 9 is a schematic plan view showing a conveying mechanism;

FIG. 10 is a schematic diagram showing the manner in which the cleaning device is driven;

FIG. 11 is a schematic diagram showing the manner in which the nozzle forming surface of the unit head portion is wiped;

FIG. 12 is a schematic diagram showing a portion of the configuration of a known inkjet printer; and

FIG. 13 is a cross-sectional view along line 13-13 in FIG. 12.

### DESCRIPTION OF THE EXEMPLARY EMBODIMENTS

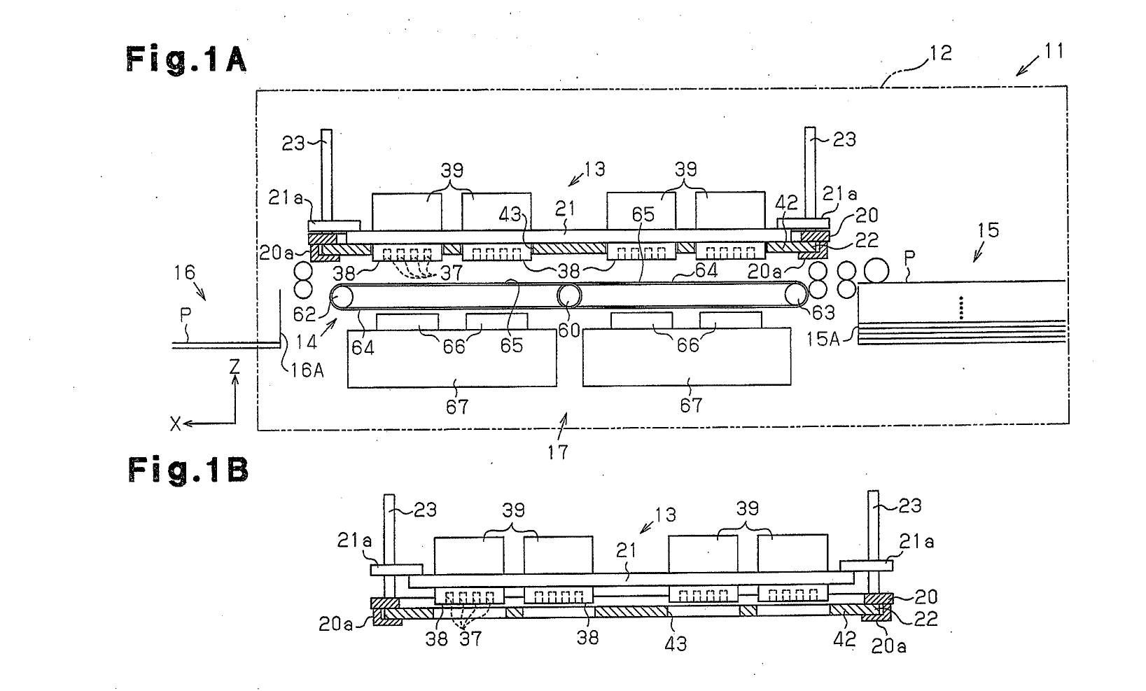

In the following, the inkjet printer according to one embodiment of the present invention is described in reference to FIGS. 1 to 11. In FIG. 1A, the upward direction is defined as a Z direction, the leftward direction is defined as an X direction, and a direction toward and perpendicular to the sheet of FIG. 1A is defined as a Y direction.

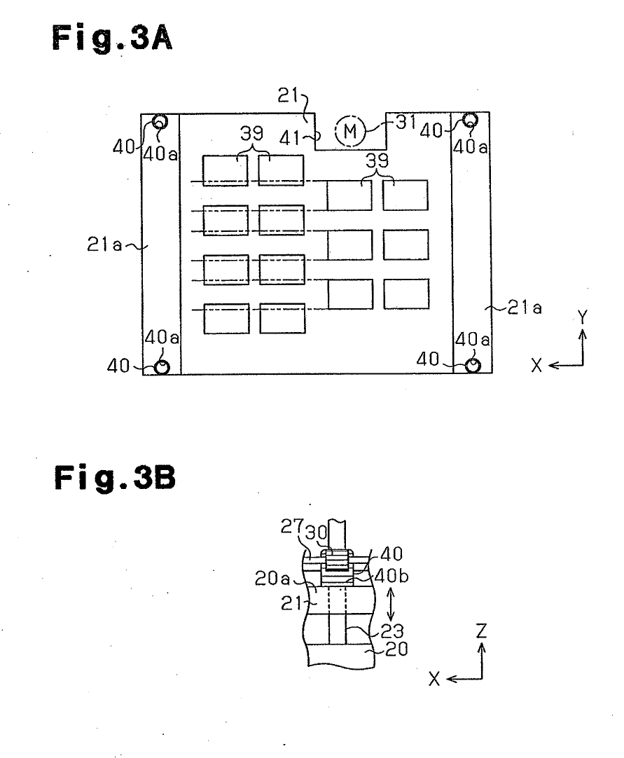

As shown in FIGS. 1A and 1B, an inkjet printer 11, which is a liquid ejection apparatus, is provided with a main body frame 12 (shown by two-dot chain line in FIG. 1) in substantially box form, and a recording head 13, which is a liquid ejection head for ejecting ink, which is liquid, onto a sheet of paper P, which is a target, is provided in an upper portion in the main body frame 12. The recording head 13 is a full line type recording head having a size which corresponds to the length of the paper sheet P in the direction of the width of the paper P (direction perpendicular to the surface of the sheet of FIGS. 1A and 1B, and Y direction in FIG. 3A), which is substantially perpendicular to (crosses) the direction of conveyance of the paper P (X direction). A plurality of ink cartridges (not shown) for storing ink of different colors are connected to the recording head 13 via supply tubes (not shown) or the like. In addition, during printing, the ink stored in the respective ink cartridges is supplied to the recording head 13 in a state where ink is adjusted to a predetermined pressure.

A conveying mechanism 14 for conveying paper sheet P in the X direction so that the paper passes through the location directly below (location facing) the recording head 13 is provided below (direction opposite to Z direction) the recording head 13 within the main body frame 12. In addition, a paper feeding mechanism 15 having a paper feeder tray 15A for containing paper sheets P before printing in a multilayer state is provided on one side of the location facing the recording head 13, that is, on one side of the conveying mechanism 14 (right side in FIG. 1A). A paper discharging mechanism 16 having a paper discharging tray 16A for containing printed paper sheet P is provided on the other side (left side in FIG. 1A) of the conveying mechanism 14. Furthermore, a cleaning device 17 for cleaning the recording head 13 is provided below the conveying mechanism 14.

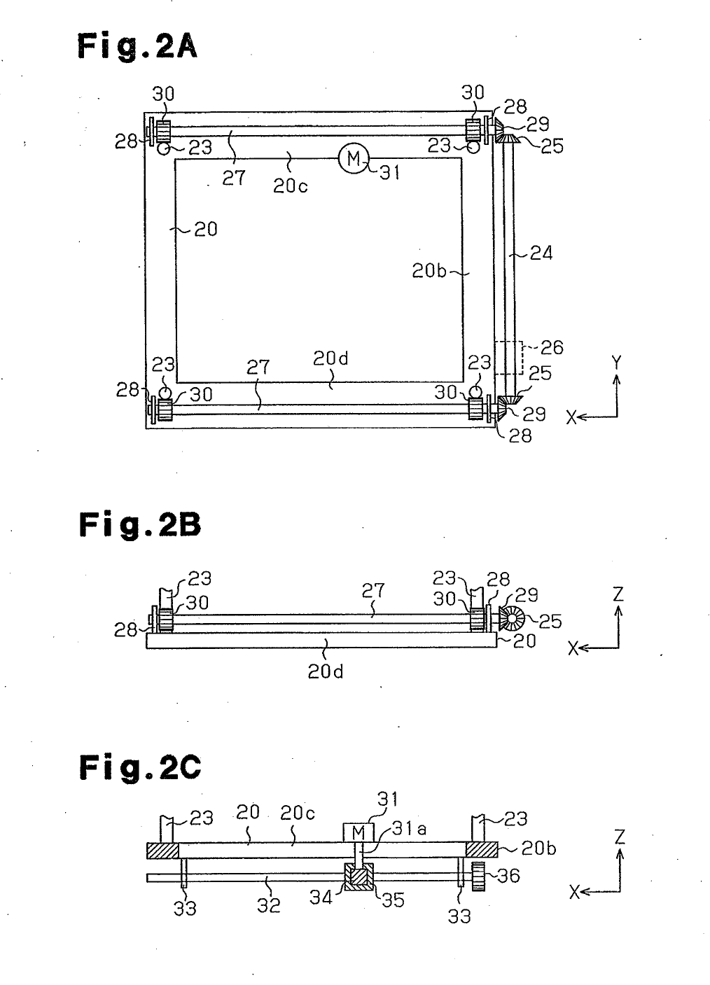

As shown in FIG. 2A, a support frame 20 in quadrilateral frame form is provided above the conveying mechanism 14, and the support frame 20 is secured to the main body frame 12 with a bracket (not shown). In addition, as shown in FIGS. 1A and 1B, a base member 21 in substantially rectangular plate form in a plan view for supporting the recording head 13 is provided inside the support frame 20 in a state where it can be moved in the Z direction and the direction opposite to the Z direction. Furthermore, on the lower side of the support frame 20, a wiping device 22 is supported by a support member 20a of which the cross section is substantially in L shape provided on the lower surface of the support frame 20 in a state where it can be moved in the Y direction and the direction opposite to the Y direction (that is, the direction perpendicular to the surface of the sheet of FIGS. 1A and 1B).

Rod members 23 are provided in the four corners on the support frame 20 so as to stand and extend in the Z direction. In addition, a first rotary shaft 24 is supported by a support portion (not shown), in a rotatable state, and extends along the frame portion 20b, which extends in the Y direction (that is to say, extends in the Y direction, which is the direction of the width of paper sheet P) and is located on a side opposite to the X direction (right side in FIG. 2A) from among the four frame portions forming the four sides of the support frame 20. A bevel gear 25 is provided in each of the two end portions of this first rotary shaft 24. In addition, a first drive motor 26 is attached to the frame portion 20b for supporting the first rotary shaft 24 in the support frame 20, as shown by a broken line in FIG. 2A, and the rotation of this first drive motor 26 is transmitted via a rotation transmitting mechanism (not shown) so that the first rotary shaft 24 rotates.

A second rotary shaft 27 which extends in the X direction is provided in each of the two frame portions 20c and 20d which extend in the X direction, along which the paper sheet P is conveyed, from among the frame portions of the support frame 20, as shown in FIG. 2B. A support portion 28 which functions as a bearing is provided in each end portion of the two frame portions 20c and 20d, which are the four corners of the support frame 20, and each of the second rotary shafts 27 is supported on the support frame 20 via the respective support portions 28 to be rotatable. In addition, a bevel gear 29 which engages with the bevel gear 25 of the first rotary shafts 24 is provided in each end portion of the second rotary shafts 27 on the side toward the direction opposite to the X direction. In addition, each second rotary shaft 27 rotates as a result of the drive force transmitted via the two bevel gears 25 and 29 when the first rotary shaft 24 rotates as a result of the rotation of the first drive motor 26. Furthermore, an external tooth type first pinion 30 is provided in each portion in each second rotary shaft 27 which corresponds to a rod member 23 in the X direction.

In addition, as shown in FIGS. 2A and 2C, a second drive motor 31 having a rotary shaft 31a which extends below the support frame 20 is provided in the frame portion 20c, which is located on a front side in the Y direction (upper side in FIG. 2A) from among the two frame portions 20c and 20d which extend in the X direction in the support frame 20. Furthermore, a third rotary shaft 32 which extends in the X direction is supported by support portions 33 which are formed so as to project downward from the support frame 20 to be rotatable on the rear side in the Z direction of the support frame 20, and a worm wheel 35 which engages with a worm 34 provided in the rotary shaft 31a of the second drive motor 31 is provided in the third rotary shaft 32. In addition, an external tooth type second pinion 36 is provided in the rear end portion in the X direction of the third rotary shaft 32. In addition, the third rotary shaft 32 rotates as a result of the rotation of the second drive motor 31 through the engagement between the worm 34 and the worm wheel 35. The second rotary shaft 27 and the like are not shown in FIG. 2C for the sake of convenience.

Next, the recording head 13 is described below in reference to FIGS. 1A, 1B and 3.

As shown in FIGS. 1A, 1B and 3A, the recording head 13 is provided with a plurality of unit head portions 39 (fourteen in the present embodiment), each of which has a nozzle forming surface 38 where a plurality of nozzle openings 37 are created, and each unit head portion 39 is supported in such a manner as not to be moveable relative to the base member 21. A plurality of nozzle rows (four in the present embodiment) which extend in the Y direction, which is the direction of the width of the paper sheet P, are formed on each nozzle forming surface 38 in rectangular form on the lower surface of each unit head portion 39 at predetermined intervals in the X direction, which is the direction in which the paper sheet P is conveyed. In addition, as shown in FIG. 3A, all of the unit head portions 39 are arranged in such a manner that a plurality of head rows (four rows in the present embodiment) are formed in the Y direction.

Specifically, two head rows on the front side (left side in FIG. 3A) in the X direction are arranged in such a manner that a plurality of unit head portions 39 (four in the present embodiment) are at a distance from each other at predetermined intervals in the Y direction for each head row. In addition, two head rows on the rear side (right side in FIG. 3B) in the X direction are arranged in such a manner that a plurality of unit head portions 39 (three in the present embodiment) are at a distance from each other at predetermined intervals in the Y direction for each head row. In addition, the unit head portions 39 which form two head rows on the rear side in the X direction are arranged in such a manner that each unit head portion 39 is aligned with the predetermined intervals created between adjacent unit head portions 39 in the Y direction which form the two head rows on the front side in the X direction. The above described predetermined intervals are set shorter than the width of the nozzle forming surface 38 in the unit head portions 39 in the Y direction.

Therefore, when paper sheet P that is conveyed to a location directly below the recording head 13 is printed by the recording head 13 in the present embodiment, the unit head portions 39 which form the two head rows on the front side in the X direction eject ink in locations where the unit head portions 39 which form the two head rows on the rear side in the X direction cannot eject ink. Accordingly, the recording head 13 in the present embodiment is formed in such a manner that the unit head portions 39 which form the recording head 13 can eject ink in the entire ink ejection region (liquid ejection region) on the paper sheet P in the direction of the width of the paper sheet P (Y direction).

In addition, side plates 21a are secured to the two side edges of the base member 21 in the X direction in a state where a portion of each side plate 21a on the rear surface makes contact with the surface of the base member 21 on a front side in the Z direction (front surface). In addition, as shown in FIGS. 3A and 3B, a boss portion 40 is formed in each location corresponding to each rod member 23 provided on the above described support frame 20, and a through hole 40a through which a rod member 23 is inserted in the Z direction is created in each boss portion 40. In addition, a rack portion 40b in rack form (see FIG. 3B) which engages with the first pinion 30 which is secured to the second rotary shaft 27 is formed on the outer circumferential surface in each boss portion 40. Therefore, when each second rotary shaft 27 rotates as a result of the rotation of the first rotary shaft 24, each first pinion 30 of each second rotary shaft 27 engages with the rack portion 40b of each boss portion 40, and thus, as shown in FIGS. 1A and 1B, the base member 21 (recording head 13) moves forward and rearward in the Z direction.

Accordingly, in the present embodiment, the first drive motor 26, the first rotary shaft 24, the bevel gears 25 and 29, the second rotary shafts 27, the first pinions 30 of the second rotary shafts 27, and the rack portions 40b of the boss portions 40 form a moving device for moving the recording head 13 relative to the conveying mechanism 14 in a predetermined direction (Z direction) in such a manner that the recording head 13 approaches and moves away from the conveying mechanism 14. As shown in FIG. 3A, a notch 41 for preventing the second drive motor 31 and the base member 21 from making contact is created in a location of the base member 21 which corresponds to the second drive motor 31 provided in the above described support frame 20.

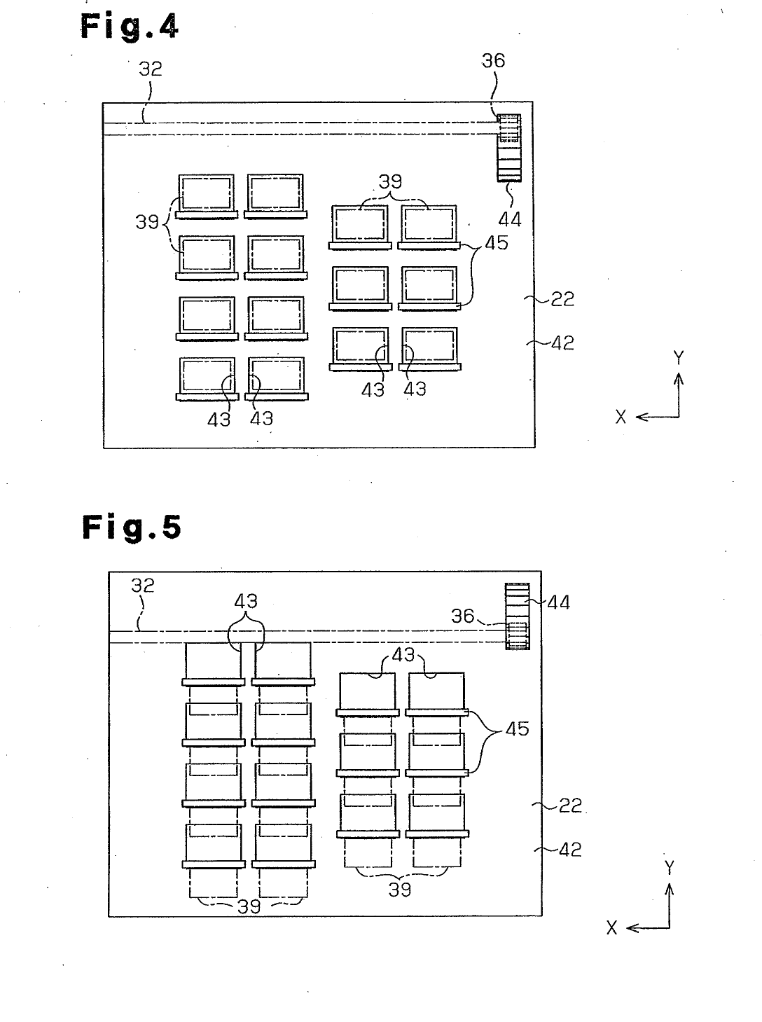

Next, the wiping device 22 is described below in reference to FIGS. 4 to 8.

As shown in FIG. 4, the wiping device 22 is provided with a support member 42 in substantially rectangular plate form. A plurality of through holes 43 in rectangular form (fourteen in the present embodiment) which individually correspond to the unit head portions 39 forming the recording head 13 are created in this support member 42. These through holes 43 are created in such a manner that the width in the X direction and the width in the Y direction of each hole are greater than the width in the X direction in the width in the Y direction of the nozzle forming surface 38 of the corresponding unit head portion 39, respectively. Therefore, when the recording head 13 moves so as to approach the conveying mechanism 14 in the Z direction at the time of printing on a paper sheet P, the unit head portions 39 are inserted into the corresponding through holes 43. Meanwhile, when the recording head 13 is farthest from the conveying mechanism 14 in the Z direction, the nozzle forming surface 38 of each unit head portion 39 is located slightly on the front side in the Z direction of the surface (upper surface) of the support member 42 in the Z direction, as shown in FIG. 1B.

In addition, a rack 44 which engages with the second pinion 36 (shown by dashed line in FIG. 4) of the above described third rotary shaft 32 is provided on the support member 42 in the Y direction. In addition, when the second drive motor 31 rotates, as shown in FIGS. 4 and 5, the support member 42 moves forward and rearward in the Y direction in accordance with the manner in which the second drive motor 31 rotates. As shown in FIG. 5, when the support member 42 moves in the Y direction when the nozzle forming surface 38 of the unit head portion 39 is wiped, an end portion of the unit head portion 39 (nozzle forming surface 38) corresponding to each through hole 43 on a front side in the Y direction is located slightly rearward of the end portion of each through hole 43 along the Y direction.

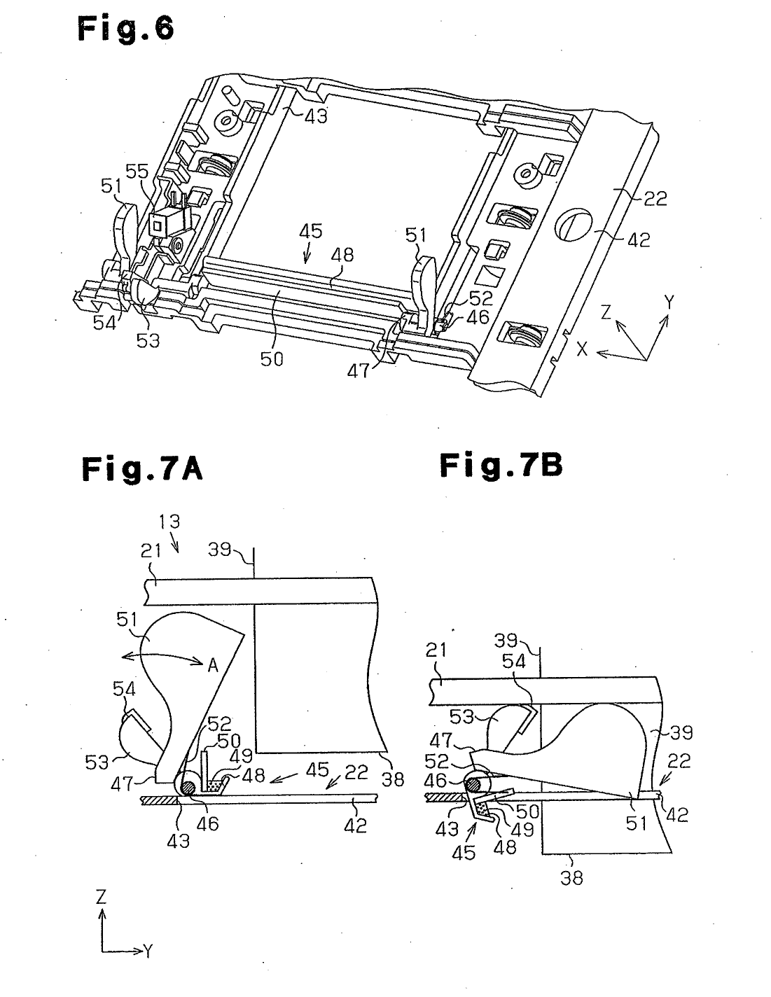

In addition, as shown in FIG. 6, a wiping mechanism 45 for wiping the nozzle forming surface 38 of each unit head portion 39 is provided on the support member 42 for each unit head portion 39. These wiping mechanisms 45 are arranged rearward of and in close proximity to the end portion of the corresponding through holes 43 along the Y direction.

The respective wiping mechanisms 45 are provided with a shaft member 46 which extends in the X direction, and each shaft member 46 is supported by the support member 42 with a support member (not shown) in such a manner as not to be rotatable and as to extend so as to cross a region slightly above the through hole 43 in the X direction in a location slightly forward along the Y direction from the end portion of the corresponding through hole 43 on a rear side the Y direction. In addition, each wiping mechanism 45 is provided with a rotational member 47 in substantially cylindrical form which is formed in such a manner as to be rotatable around the shaft member 46 in a state where substantially the entirety of the shaft member 46, excluding the two end portions, penetrates through the rotational member.

In the outer portion forward along the Y direction of the shaft member 46 (that is to say, on the center of the through hole 43) in each of these rotational members 47, a groove 48 is created as a recess for containing liquid so as to extend in the X direction. In addition, as shown in FIGS. 7A and 7B, an ink absorbing body 49 (for example, an absorbing body made of a porous material) is contained within each groove 48 as a liquid absorbing body.

In addition, each rotational member 47 is provided with a wiping member 50 made of a synthetic resin in plate form which is formed longer than the nozzle forming surface 38 in the X direction in each unit head portion 39 on a rear side in the Y direction of the groove 48 containing an ink absorbing body 49. In addition, when the wiping member 50 becomes of a standing state in the Z direction, the support member 42 moves in the Y direction in a state where the distal end portion slides against (makes contact with) the nozzle forming surface 38 of the unit head portion 39, and thus, the entirety of the nozzle forming surface 38 of each unit head portion 39 is wiped by the corresponding wiping member 50. In addition, as described above, a groove 48 is created in close proximity to the proximal end portion of each wiping member 50. Therefore, when the nozzle forming surface 38 of each unit head portion 39 is wiped, ink that is wiped off each nozzle forming surface 38 is absorbed by the ink absorbing body 49 inside each groove 48.

As shown in FIGS. 6 and 7A, when the wiping member 50 is in a standing state, a first protrusion 51 is formed so as to protrude from the rear end portion of each rotational member 47 along the X direction in such a manner as to extend diagonally upward (diagonally upward to the right in FIG. 7A) at an angle of approximately 65 degrees relative to the upper surface of the support member 42. Each of these first protrusions 51 is formed so as to have such a length that the distal end portion (upper end portion), of which the top surface is formed in arc form, is located above the end (upper end) of the wiping member 50 (in the Z direction) when the wiping member 50 is in a standing state. In addition, when the recording head 13 moves downward (direction opposite to the Z direction) from above, the configuration of each first protrusion 51 allows the top surface of the end portion to make contact with the base member 21 of the recording head 13, and each of the first protrusions 51 is pressed down by the base member 21. Thus, each of the wiping members 50 in a standing state rotates around the shaft member 46. In addition, the end of a torsion spring 52 wound around the shaft member 46 is engaged with the first protrusion 51, and this torsion spring 52 engages with the first protrusion 51, and thus, presses the rotational member 47 forward and rearward along the A direction in the figure, so that the wiping member 50 is always in a standing state, as shown in FIG. 7A.

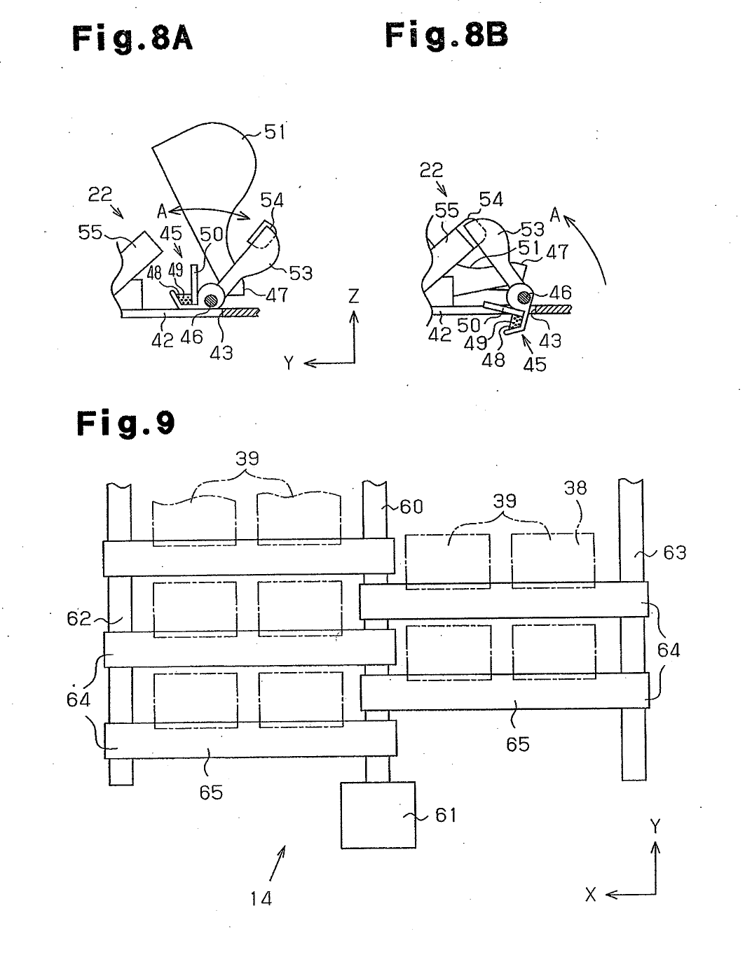

Meanwhile, as shown in FIGS. 6, 8A and 8B, a second protrusion 53 is formed on the end portion of each rotational member 47 along the X direction. When the wiping member 50 is in a standing state, the second protrusion 53 extends diagonally upward to the side of the upper surface of the support member 42 opposite to the first protrusion 51 (diagonally upward to the left in FIG. 7A and diagonally upward to the right in FIG. 8A). That is, the second protrusion 53 is provided on the upper surface of the support member 42 so as to be further displaced at an angle of approximately 65 degrees relative to the first protrusion 51 in the direction opposite to the A direction. In addition, when the wiping member 50 is in a standing state, each of these second protrusions 53 has such a length that the distal end portion to which a conductive member 54 (for example an iron plate) is attached is located above the end (upper end) of the wiping member 50 (in the Z direction) and below the end of the first protrusion 51.

In addition, when the recording head 13 moves down from the location shown in FIG. 7A (in the direction opposite to the Z direction), the base member 21 of the recording head 13 presses down the first protrusion 51 of each rotational member 47. Therefore, each rotational member 47 and each wiping member 50 rotates in the A direction shown in FIG. 7A, against the pressing force of each torsion spring 52, and becomes of the state shown in FIG. 7B. In this case, as shown in FIG. 8B, the conductive member 54 provided in the second protrusion 53 of each rotational member 47 makes contact with an electromagnet 55 provided on the support member 42.

In this state, when the recording head 13 moves in the Z direction without a current being supplied to the electromagnet 55, the force for pressing each first protrusion 51 in the direction opposite to the Z direction is cancelled in the first protrusion 51 in each rotational member 47. Therefore, each rotational member 47 and each wiping member 50 rotates in the direction opposite to the A direction, as a result of the force applied by each torsion spring 52 in each first protrusion 51, and becomes of the state shown in FIG. 7A. Accordingly, in the present embodiment, the base member 21 of the recording head 13, the first protrusion 51 of each rotational member 47 and each torsion spring 52 form a displacement device for displacing the location of the wiping member 50.

Meanwhile, when the recording head 13 moves in the Z direction in a state where a current is being supplied to the electromagnet 55 as a result of a control signal from a control device (not shown) an electromagnetic force works between each electromagnet 55 and a conductive member 54 provided in each second protrusion 53 which corresponds to the electromagnet 55. Therefore, even when the recording head 13 moves in the Z direction and the force for pressing the first protrusion 51 of each rotational member 47 in the direction opposite to the Z direction is cancelled, each rotational member 47 and each wiping member 50 resists the force applied to each first protrusion 51 by each torsion spring 52, and maintains the state shown in FIG. 7B. That is, even when the state where the base member 21 and the first protrusion 51 make contact is lost, such a state that the wiping member 50 is not standing (that is, a state where the unit head portion 39 cannot make contact with the nozzle forming surface 38) is maintained.

Next, the conveying mechanism 14 is described below in reference to FIGS. 1 and 9.

As shown in FIG. 9, the conveying mechanism 14 is provided with a drive shaft 60 which extends in the Y direction and a drive motor 61 for applying a drive force to the drive shaft 60, and the drive shaft 60 rotates as a result of the drive force applied by the drive motor 61. In a position forward of the drive shaft 60 along the X direction, a first driven shaft 62 which extends in the Y direction is provided on a front side in the X direction of the unit head portion 39, which is located foremost in the X direction from among the unit head portions 39. In addition, in a position rearward of the drive shaft 60 along the X direction, a second driven shaft 63 which extends in the Y direction is provided on a rear side in the X direction of the unit head portion 39 which is located rearmost in the X direction from among the unit head portions 39. The respective driven shafts 62 and 63 are placed in the same location as the drive shaft 60 in the Z direction, as shown in FIG. 1A.

As shown in FIG. 9, endless conveying belts 64 are engaged on the drive shaft 60 and the first driven shaft 62 at constant intervals corresponding to the width of the unit head portions 39 in the Y direction. Likewise, endless conveying belts 64 are engaged on the drive shaft 60 and the second driven shaft 63 at constant intervals corresponding to the width of the unit head portions 39 in the Y direction. In addition, the conveying surface 65 of each conveying belt 64 on which a paper sheet P is placed becomes substantially parallel to each nozzle forming surface 38 in the location where the conveying surface 65 faces the nozzle forming surface 38 of each unit head portion 39. That is, the conveying surface 65 of the conveying belts 64 on which paper sheet P can be placed becomes a portion of the recording head 13 which faces the nozzle forming surface 38.

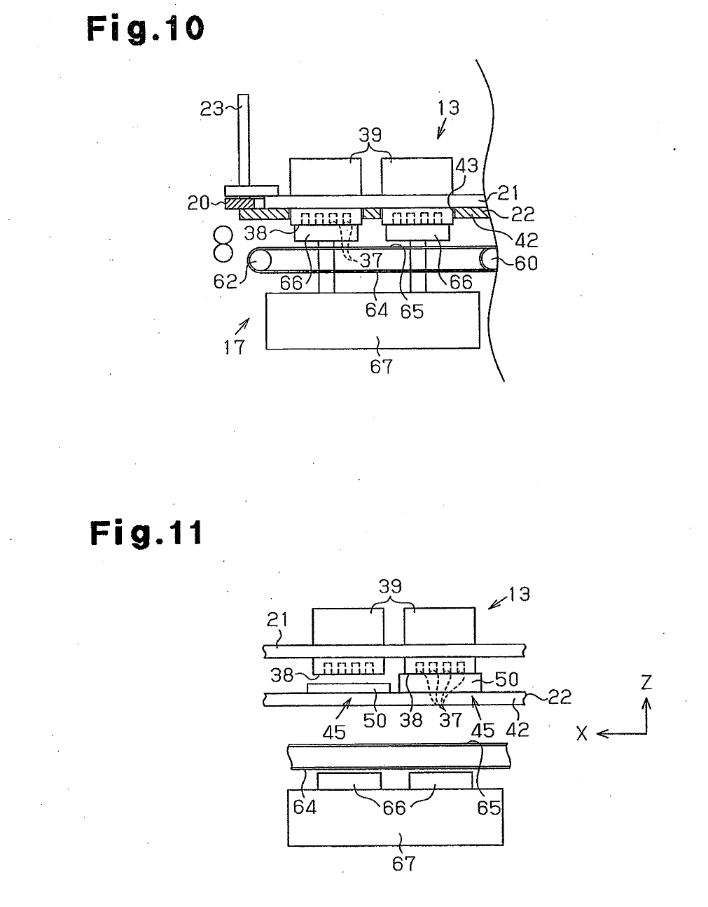

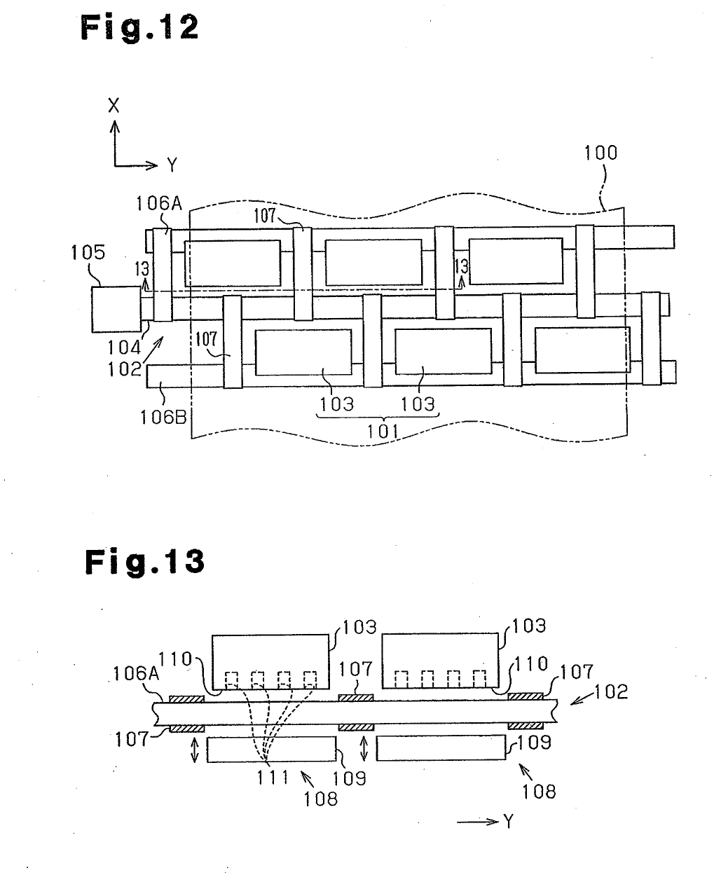

Next, a cleaning device 17 is described below in reference to FIGS. 1 and 10.

As shown in FIG. 1A, the cleaning device 17 is placed below the conveying mechanism 14 (in the direction opposite to the Z direction), and a cap member 66 which is formed so that it can make contact with a unit head portion 39 as to surround each nozzle opening 37 created in the nozzle forming surface 38 of each unit head portion 39 is provided for each unit head portion 39. In addition, as show in FIG. 10, each cap member 66 is lifted and lowered through the space between adjacent conveying belts 64 in the Y direction as a result of the drive of a lift device 67.

That is, as shown in FIGS. 1A, 7B and 10, the cleaning device 17 makes contact with the nozzle forming surface 38 of unit head portions 39, each of which corresponds to each cap member 66 in a state where each unit head portion 39 is inserted through each through hole 43 of the support member 42 as the recording head 13 moves down from the base member 21. In addition, negative pressure is created within the cap member 66 as a result of the drive of a suction pump (not shown) in the above described state. Thus, cleaning is carried out, so that thickened ink and bubbles are forcefully sucked out and removed from the nozzle opening 37 in each unit head portion 39 in the recording head 13. A cap member 66 corresponding to each unit head portion 39 is provided in the cleaning device 17 in the present embodiment. Therefore, it is possible to selectively clean the recording head 13 in unit head portions 39 which require cleaning.

Next, the operation of each unit head portion 39 which forms the recording head 13 is described below in reference to FIG. 11 in the case where the nozzle forming surface 38 is wiped after the completion of cleaning of the recording head 13.

When cleaning of the recording head 13 is completed, each cap member 66 which makes contact with each unit head portion 39 at the time of cleaning as shown in FIG. 10 moves downward (in the direction opposite to the Z direction) as a result of the drive of the lift device 67. Thus, each unit head portion 39 and each cap member 66 becomes of a non-contact state. Then, the lift device 67 stops being driven, when each cap member 66 moves to a location below the conveying mechanism 14.

In addition, as shown in FIGS. 1B and 7A, the base member 21 moves in the Z direction (upward) as a result of the drive of the first drive motor 26, and the recording head 13 moves upward and out through the through hole 43 corresponding to each unit head portion 39. Then, the recording head 13 moves to such a location that the nozzle forming surface 38 of each unit head portion 39 is slightly above the upper surface of the support member 42. That is, the recording head 13 moves to such a location as to be able to slide against the nozzle forming surface 38 of the unit head portion 39 with the wiping member 50 in a standing state having sufficient wiping force. Thus, in this state, a wiping process for wiping off ink which adheres to the nozzle forming surface 38 of each unit head portion 39 is carried out. In the wiping mechanism 45 which corresponds to the unit head portion 39 where cleaning is not carried out from among the unit head portions 39 at this time, a current is supplied to the electromagnet 55 as a result of a control signal from a control device (not shown) before the base member 21 starts moving upward.

Then, in a wiping mechanism 45 in which no current is supplied to the electromagnet 55 among the wiping mechanisms 45 provided in the support member 42, the rotational member 47 and the wiping member 50 rotate in the direction opposite to the A direction as a result of the force of each torsion spring 52 pressing against each first protrusion 51, and the wiping member 50 extends in the Z direction and becomes of a standing state (see FIG. 7A). That is, the wiping member 50 is displaced to a sliding position where it can slide against the nozzle forming surface 38 of the unit head portion 39 which corresponds to the wiping member 50.

Meanwhile, in the wiping mechanism 45 where a current is being supplied to the electromagnet 55 from among the wiping mechanisms 45, electromagnetic force works between the electromagnet 55 and the conductive member 54 which makes contact with the electromagnet 55, even when the recording head 13 moves in the Z direction together with the base member 21. Thus, displacement of the rotational member 47 and the wiping member 50 in the direction opposite to the A direction is restricted. That is, in this case, the wiping member 50 is placed in a retracted position where it cannot slide against the nozzle forming surface 38 of the unit head portion 39 corresponding to the wiping member 50.

When the second drive motor 31 rotates in this state, the support member 42 starts moving in the Y direction from the location shown in FIG. 4. Then, the wiping member 50 placed in a sliding position wipes the entirety of the nozzle forming surface 38 of the unit head portion 39 which corresponds to the wiping member 50 (wiping mechanism 45), as shown in FIG. 11. Meanwhile, the nozzle forming surface 38 of the unit head portion 39 which corresponds to the wiping member 50 (wiping mechanism 45) placed in the retracted position is not wiped.

In addition, when the support member 42 moves to the location shown in FIG. 5, the wiping member 50, which is placed in the sliding position, wipes the nozzle forming surface 38 of the corresponding unit head portion 39, sliding from the rear end portion to the front end portion along the Y direction. Therefore, the second drive motor 31 once stops. As a result, the entirety of the nozzle forming surface 38 is reliably wiped by the wiping member 50 in the unit head portion 39 having the nozzle forming surface 38 to be wiped. Ink that has been wiped off the nozzle forming surface 38 by the wiping member 50 is absorbed into the ink absorbing body 49 contained inside the groove 48 in the wiping mechanism 45.

Next, the recording head 13 moves further upward together with the base member 21 and places the nozzle forming surface 38 of all of the unit head portions 39 above the upper end portion (the front end portion along the Z direction) of the wiping member 50 in a standing state (that is, located in a sliding position). After that, when the second drive motor 31 rotates in the opposite direction, the support member 42 moves in the direction opposite to the Y direction from the location shown in FIG. 5, and when the support member 42 moves to the location shown in FIG. 4, the second drive motor 31 stops rotating. Thus, when the support member 42 moves from the location shown in FIG. 5 to the location shown in FIG. 4 in the direction opposite to the Y direction, the nozzle forming surface 38 of the unit head portion 39 does not slide against the wiping member 50 corresponding to the unit head portion 39. Therefore, the nozzle forming surface 38 of the unit head portion 39 is not unnecessarily wiped.

The present embodiment has the following advantages.

(1) The support member 42, on which the wiping members 50 are mounted, is placed in a location between the nozzle forming surface 38 and the conveying surface 65 when the recording head (liquid injection head) 13 has moved in the Z direction (predetermined direction) as a result of the rotation of the first drive motor 26. In other words, the wiping members 50 are placed on a side corresponding to the recording head 13 of the conveying belt 64 in the up-down direction. Therefore, the form, the size, and the manner of movement of the wiping members are not restricted by the conveying mechanism 14, unlike in the case of the prior art. Accordingly, the entirety of the nozzle forming surface 38 facing paper (target) P is reliably wiped with a wiping member having a form, size, and manner of movement which are appropriate for wiping the nozzle forming surface 38 when liquid is injected onto the paper sheet P in the recording head 13.

(2) Wiping members 50, which individually correspond to unit head portions 39, are provided in the support member 42. Therefore, the nozzle forming surfaces 38 of the unit head portions 39 are reliably wiped with the wiping members 50, which individually correspond to the unit head portions 39.

(3) A wiping member 50 which corresponds to a unit head portion 39 that wipes the nozzle forming surface 38 is located in a sliding position by means of a displacing device formed of a base member 21, a first protrusion 51, and a torsion spring 52, while a wiping member 50 which corresponds to a unit head portion 39 that does not wipe the nozzle forming surface 38 is located in an retracted position. That is to say, the displacing device displaces the wiping members 50 between the sliding position and the retracted position, and thus, a unit head portion 39 for wiping the nozzle forming surface 38 can be selected.

(4) The wiping members 50 are provided in the support member 42, which moves in the wiping direction which is the direction along the nozzle forming surface 38. Therefore, the configuration contributes to the miniaturization of the inkjet printer 11, unlike the case where moving mechanisms for individually moving all the wiping members 50 are provided for the respective wiping members 50.

(5) The wiping members 50 are respectively placed in close proximity to the through holes 43 in the support member 42, which has a plurality of through holes 43 through which a unit head portion 39, which moves in the Z direction, is inserted. Therefore, it becomes possible to place the wiping members 50 in close proximity to unit head portions 39, which individually correspond to the wiping members 50. Therefore, the moving distance of the wiping member 50 is shortened when the nozzle forming surface 38 is wiped. That is to say, the time that it takes to wipe the nozzle forming surface 38 of each unit head portion 39 is shortened.

(6) In addition, the grooves (recesses for containing liquid) 48 are created in close proximity to the proximal end portions of the wiping members 50, respectively, in the support member 42. Therefore, ink (liquid) that has been wiped off the nozzle forming surface 38 when the nozzle forming surface 38 of a unit head portion 39 is wiped is contained within a groove 48. Accordingly, ink that has been wiped off the nozzle forming surface 38 (also referred to as “waste ink”) is prevented from flowing downward (in the direction opposite to the Z direction) and staining the paper sheet P that has been conveyed on the conveying surface 65 of the conveying belts 64 in the conveying mechanism 14 and by the conveying mechanism 14.

(7) In addition, ink (liquid) contained inside the grooves (recesses for containing liquid) 48 is absorbed by the ink absorbing body (liquid absorbing body) 49. Therefore, even when the wiping mechanism 45 becomes of an inclined state as shown in FIG. 7(b), ink that has been wiped off the nozzle forming surface 38 can be well prevented from flowing downward (in the direction opposite to the Z direction).

(8) The support member 42, on which the wiping members 50 are mounted, is placed above the conveying belts 64. Therefore, it is not necessary to make the width of the respective conveying belts 64 smaller than the intervals between adjacent unit head portions 39 in the Y direction. Accordingly, the efficiency in conveying a paper sheet P by means of the conveying mechanism 14 is reliably prevented from decreasing.

The above described embodiment may be modified as follows.

The respective unit head portion 39 do not need to be moved upward (in the Z direction) when the support member 42 is moved from the location shown in FIG. 5 to the location shown in FIG. 4 after the nozzle forming surface 38 of a unit head portion 39 has been wiped. In this case, the unit head portions 39, which individually correspond to the wiping members 50 located in a sliding position, are wiped twice in a one-time wiping process (reciprocating movement of the support member 42).

The configuration may be such that when the nozzle forming surface 38 of each unit head portion 39 is wiped, the conveying mechanism 14 (each conveying belt 64) moves in the direction opposite to the Z direction. In this case, it is desirable for the support member 42 to move in the direction opposite to the Z direction together with the conveying mechanism 14 in the configuration. This configuration obtains the same advantages as the above described embodiment.

In addition, the configuration may be such that when the nozzle forming surface 38 of each unit head portion 39 is wiped, the recording head 13 moves in the Z direction, and at the same time, the conveying mechanism 14 moves in the direction opposite to the Z direction in such a manner that the nozzle forming surface 38 and the conveying surface 65 move away from each other.

The configuration does not need to provide an ink absorbing body 49 inside each groove 48. In the case of this configuration as well, the above described advantages (1) to (6) are obtained.

No groove 48 may be provided in each wiping mechanism 45. In the case of this configuration as well, the above described advantages (1) to (5) are gained.

The through holes 43 created in the support member 42 may have a form which corresponds to each row formed of the unit head portions 39. In this case, four through holes 43 which extend in the Y direction are created in the support member 42 in the X direction.

Furthermore, the support member 42 may have a configuration where a wiping mechanism 45 is provided for each of the above described rows instead of each of the unit head portions 39. In this case, the distance in which the support member 42 moves in the Y direction when each unit head portion 39 wipes the nozzle forming surface 38 becomes long in comparison with the case of the above described embodiment.

Each wiping mechanism 45 may have a configuration where the wiping members 50 cannot be displaced. That is to say, the configuration may be such that all the nozzle forming surfaces 38 are always wiped when the nozzle forming surfaces 38 of the unit head portions 39 are wiped. This configuration also obtains the above described advantages (1) and (2).

The support member 42 may be placed on a side of the recording head 13 (for example, on a rear side along the Y direction) when the nozzle forming surface 38 of each unit head portion 39 is not wiped. In this case, no through holes 43 may be provided in the support member 42. This configuration also obtains the above described advantage (1).

The size of each unit head portion 39 may differ for each unit head portion 39. In this case, it is desirable for the intervals between adjacent conveying belts 64 in the Y direction to be intervals which correspond to the size and the form of the unit head portions 39 which are located between the conveying belts 64.

Although in the above described embodiment the configuration is such that the recording head 13 is provided with a plurality of unit head portions 39, the recording head 13 may be formed of one head portion.

In the above described embodiment, the conveying mechanism may have a configuration in which a plurality of rollers are placed parallel to each other at predetermined intervals in the direction in which paper sheet P is conveyed. In this case, an imaginary plane which extends along the conveying direction of a paper sheet in such a manner as to connect the top portions of the outer circumferential surfaces of the rollers is a conveying surface (facing portion).

Although in the above described embodiment, a case where the liquid ejection apparatus according to the present invention is applied to an inkjet printer is described, the present invention may be applied to other liquid ejection apparatuses in the same manner without being restricted to the above described printer. The present invention may be applied to, for example, a printing apparatus used in a facsimile or a copier, a liquid ejection apparatus for ejecting liquid, such as an electrode material or color material used for the manufacture of liquid crystal displays, EL displays, and surface light emitting displays. The present invention may also be applied to a liquid ejection apparatus for ejecting a bioorganic material used for the manufacture of biochips, or a sample ejection apparatus, such as a precise pipette.

What is claimed is:

1. A liquid ejection apparatus for ejecting liquid onto a target, comprising:
a liquid ejection head having a nozzle forming surface, wherein the liquid ejection head has a nozzle opening through which liquid is ejected;
a conveying mechanism for conveying the target along the nozzle forming surface toward a facing location which faces the nozzle forming surface from a side of the facing location;
a moving device for making at least one of the liquid ejection head and the conveying mechanism approach and move away from the other in a predetermined direction while maintaining a state where the nozzle forming surface and the conveying mechanism face each other; and
a wiping device having a wiping member for wiping the nozzle forming surface by sliding against the nozzle forming surface, wherein, with respect to the predetermined direction, the wiping member is placed on a side of the conveying mechanism corresponding to the liquid ejection head.

2. The liquid ejection apparatus according to claim 1, wherein the wiping member is displaceable between a sliding position, at which the wiping member is permitted to slide against the nozzle forming surface, and a retracted position, at which the wiping member is not permitted to slide against the nozzle forming surface, and wherein, with respect to the predetermined direction, the wiping member is placed on a side of the conveying mechanism that corresponds to the liquid ejection head regardless of whether the wiping member is in the sliding position or the retracted position.

3. The liquid ejection apparatus according to claim 1, wherein the liquid ejection head is provided with a plurality of unit head portions individually having a nozzle forming surface where a nozzle opening is created,
wherein the unit head portions are placed in such a manner that liquid is ejected in the entirety of a liquid ejection region of the target in the direction crossing the direction in which the target is conveyed, and
wherein the wiping member is one of a plurality of wiping members, each of which is provided to correspond to one of the unit head portions.

4. The liquid ejection apparatus according to claim 3, wherein the wiping device has displacing devices, each of which corresponds to one of the wiping members, and each displacing device displaces the corresponding wiping member between the sliding position, at which the wiping member is permitted to slide against the nozzle forming surface of a unit head portion and the retracted position, at which the wiping member is not permitted to slide against the nozzle forming surface.

5. The liquid ejection apparatus according to claim 3, wherein the wiping device has a support member which supports the wiping members in locations corresponding to the unit head portions individually, and wherein the support member is movable in the direction in which the nozzle forming surface is wiped.

6. The liquid ejection apparatus according to claim 3, wherein the conveying mechanism is provided with a plurality of conveying belts, wherein each conveying belt faces one of nozzle forming surfaces and has a conveying surface on which the target can be placed, and wherein the conveying belts are placed at predetermined intervals which correspond to the width of the unit head portions in a direction crossing the direction in which the target is conveyed.

7. The liquid ejection apparatus according to claim 1, wherein each wiping members has a distal end portion for wiping the nozzle forming surface and a proximal end portion on a side opposite to the distal end portion, and wherein the wiping device is provided with a recess for containing liquid that is wiped off the nozzle forming surface when the nozzle forming surface is wiped by the wiping member, the recess being located in close proximity to the proximal end portion of the wiping member.

8. The liquid ejection apparatus according to claim 7, wherein the recess contains a liquid absorbing body which absorbs liquid.
